(19) United States
(12) Patent Application Publication
(10) Pub. No.: US 2019/0128126 A1
(43) Pub. Date: May 2, 2019

(54) TURBINE BLISK AND METHOD OF MANUFACTURING THEREOF

(71) Applicant: GENERAL ELECTRIC COMPANY, Schenectady, NY (US)

(72) Inventors: Douglas Carl Hofer, Clifton Park, NY (US); Rajiv Sampath, Mason, OH (US); Edip Sevincer, Watervliet, NY (US); Ganesh Krishnamoorthy, Shoreline, WA (US); Chiranjeev Singh Kalra, Niskayuna, NY (US)

(21) Appl. No.: 15/973,364

(22) Filed: May 7, 2018

Related U.S. Application Data
(63) Continuation of application No. 14/299,538, filed on Jun. 9, 2014, now abandoned.

(51) Int. Cl. F01D 5/22; F01D 5/34; B23P 15/00

(52) U.S. Cl. CPC F01D 5/225; F01D 5/34; B23P 15/006; Y10T 29/49323; F05D 2230/11; F05D 2230/53; F05D 2230/25

(57) ABSTRACT

A turbine blisk is provided. The turbine blisk includes an inner rim, a plurality of adjacent rotor blades extending radially outward from said inner rim, a shroud segment integrally coupled to each of the plurality of adjacent rotor blades, thereby forming a plurality of adjacent shroud segments, and a gap defined between each of the adjacent shroud segments. The gap has a geometry that facilitates interlocking the plurality of adjacent shroud segments when a torsional force is applied to the plurality of adjacent rotor blades.

### CROSS-REFERENCE TO RELATED APPLICATIONS

This application is a continuation of copending U.S. patent application Ser. No. 14/299,538, filed Jun. 9, 2014, titled “Turbine Blisk and Method of Manufacturing Thereof,” which is hereby incorporated by reference in its entirety.

### STATEMENT REGARDING FEDERALLY SPONSORED RESEARCH OR DEVELOPMENT

One or more embodiments of this disclosure were made with Government support under Contract No. DE-EE0005804 awarded by the Department of Energy. The Government has certain rights in said embodiment(s).

### BACKGROUND

The present disclosure relates generally to turbine engines and, more specifically, to shrouded turbine blisks for use in turbine engines.

At least some known axial flow turbine engines include a rotor shaft and at least one turbine stage coupled to the rotor shaft. At least some known stages include a disk and circumferentially-spaced apart rotor blades that extend radially outward from the disk. Each rotor blade includes an airfoil and a dovetail at its root where the dovetail is radially retained in a complementary slot in a perimeter of the disk. During operation, the disk and blades attached thereto rotate such that the blades develop a substantially centrifugal force, which is carried downwardly through the respective dovetails and into the disk. Other known stages include the rotor blades integrally manufactured with the disk as a one-piece component conventionally known as a blisk (i.e., bladed disk).

In at least some known rotary machines, the rotational speed of and/or aerodynamic forces acting on the rotating components induce vibration and axial torsion into the stages of the rotary machine. To limit such vibration and axial torsion, at least some known blades include integral shrouds extending from the airfoils at predetermined radial distances along each blade. For example, the integral shrouds facilitate increasing the overall stiffness of the stage to increase its vibrational frequencies into a more desirable range. Moreover, in stages where each rotor blade includes an individual airfoil/dovetail configuration, frictional damping between dovetails and their complementary retaining slots also facilitates supplementing damping to the rotating components. However, because known blisks including integral shrouds are manufactured as a one-piece component, such supplemental frictional damping cannot be provided to the components.

### BRIEF DESCRIPTION

In one aspect, a turbine blisk is provided. The turbine blisk includes an inner rim, a plurality of adjacent rotor blades extending radially outward from said inner rim, a shroud segment integrally coupled to each of the plurality of adjacent rotor blades, thereby forming a plurality of adjacent shroud segments, and a gap defined between each of the adjacent shroud segments. The gap has a geometry that facilitates interlocking the plurality of adjacent shroud segments when a torsional force is applied to the plurality of adjacent rotor blades.

In another aspect, a power generation system is provided. The power generation system includes a source of working fluid and a turbine coupled downstream from the source of working fluid. The turbine includes at least one turbine blisk including an inner rim, a plurality of adjacent rotor blades extending radially outward from said inner rim, a shroud segment integrally coupled to each of the plurality of adjacent rotor blades, thereby forming a plurality of adjacent shroud segments, and a gap defined between each of the adjacent shroud segments. The gap has a geometry that facilitates interlocking the plurality of adjacent shroud segments when a torsional force is applied to the plurality of adjacent rotor blades.

In yet another aspect, a method of manufacturing a turbine blisk is provided. The method includes providing a solid billet of material, defining an inner rim from the solid billet of material, defining a plurality of adjacent rotor blades from the solid billet of material, and defining a shroud from the solid billet of material. The plurality of adjacent rotor blades extend radially outward from the inner rim, and the shroud is integrally coupled to the plurality of adjacent rotor blades. The method also includes defining a gap in the shroud to form a shroud segment integrally coupled to each of the plurality of adjacent rotor blades, thereby forming a plurality of adjacent shroud segments. The gap has a geometry that facilitates interlocking the plurality of adjacent shroud segments when a torsional force is applied to the plurality of adjacent rotor blades.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary power generation system;

FIG. 2 is a perspective view of an exemplary blisk that may be used in the power generation system shown in FIG. 1;

FIG. 3 is an enlarged perspective view of the blisk shown in FIG. 2 taken along Area 3;

FIG. 4 is a schematic flow diagram illustrating an exemplary sequence of process steps of manufacturing the blisk shown in FIGS. 2; and

FIG. 5 is a schematic flow diagram illustrating an exemplary sequence of process steps of defining a gap between adjacent shroud segments in the blisk shown in FIG. 2.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

Embodiments of the present disclosure relate to turbine blisks having shroud segments integrated therein. In the exemplary embodiment, adjacent shroud segments are separated by a gap having a geometry that facilitates interlocking the adjacent shroud segments when torsional loading is applied to a rotor blade coupled to each shroud segment. Specifically, the gap geometry allows the rotor blades and the shroud segments to deflect as the rotational speed of the turbine blisk increases towards a predetermined rotational speed. As such, the gap geometry and gap size are selected to ensure frictional contact is achieved between adjacent shroud segments when the turbine blisk reaches the predetermined rotational speed, which increases frictional damping in the blisk assembly.

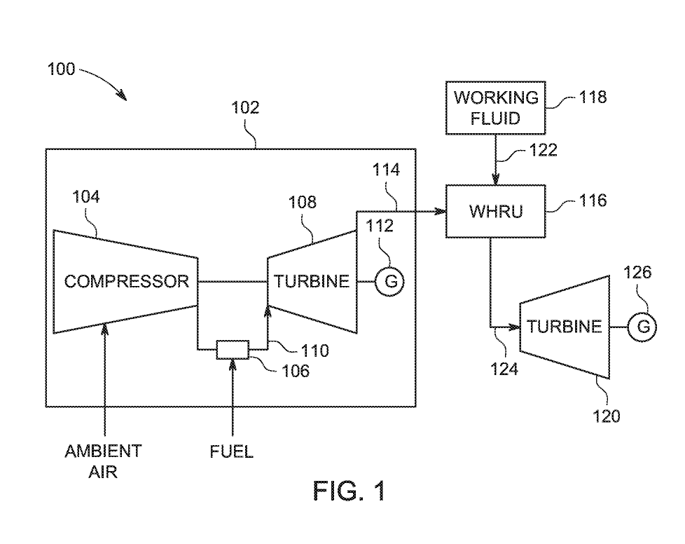

FIG. 1 is a schematic illustration of an exemplary power generation system 100. Power generation system 100 includes a gas turbine engine assembly 102 that includes a compressor 104, a combustor 106, and a first turbine 108 powered by expanding a flow of hot gas 110 produced in combustor 106 for driving a first electrical generator 112. A flow of exhaust gas 114 is channeled from turbine 108 towards a waste heat recovery unit (WHRU) 116 that recovers waste heat from exhaust gas 112. Power generation system 100 also includes a working fluid source 118 coupled in flow communication with WHRU 116, and a second turbine 120 coupled downstream from WHRU 116. A flow of working fluid 122 is channeled towards WHRU 116 and, in one embodiment, waste heat from exhaust gas 114 facilitates heating working fluid 122 to a supercritical state. Alternatively, working fluid 122 channeled towards WHRU 116 is in a supercritical state prior to entering WHRU 116. A flow of supercritical working fluid 124 is then channeled towards second turbine 120, which is powered by expanding the flow of supercritical working fluid 124 for driving a second electrical generator 126.

Working fluid 122 is any working fluid that enables power generation system 100 to function as described herein. Exemplary working fluids include, but are not limited to, carbon dioxide and steam. In an alternative embodiment, working fluid 122 may be heated by any heat source that enables power generation system 100 to function as described herein and may be in a non-supercritical state. For example, working fluid 122 may be heated by nuclear energy or concentrated solar energy.

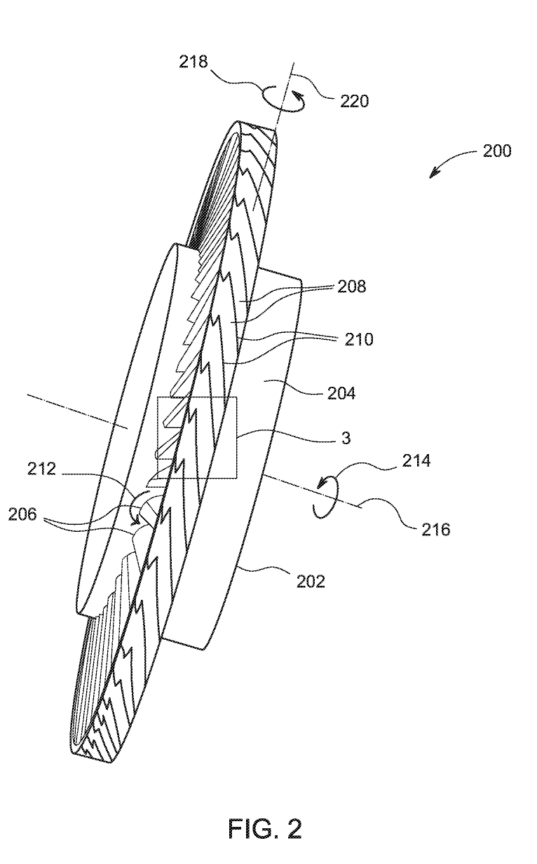

FIG. 2 is a perspective view of an exemplary blisk 200 that may be used in power generation system 100 (shown in FIG. 1). Specifically, blisk 200 is implemented in turbines 108 and 120, for example. In the exemplary embodiment, blisk 200 includes a central disk portion 202, an inner rim 204 surrounding central disk portion 202, and a plurality of rotor blades 206 extending radially outward from inner rim 204. Rotor blades 206 are positioned at regularly-spaced intervals about a circumference (not shown) of inner rim 204, and each rotor blade 206 has a substantially airfoil cross-sectional shape. Blisk 200 also includes a shroud segment 208 integrally coupled to each of the plurality of rotor blades 206. Shroud segments 208 are integrally coupled at any axial location along rotor blades 206 that enables blisk 200 to function as described herein. Moreover, as will be described in more detail below, a gap 210 is defined between adjacent shroud segments 208. Gap 210 has a geometry that allows adjacent shroud segments 208 to interlock when a torsional force 212 is applied to rotor blades 206. In an alternative embodiment, gap 210 is defined such that shroud segments 208 are coupled to more than one rotor blade 206.

In operation, blisk 200 rotates in a circumferential direction 214 about a centerline axis 216 when rotor blades 206 are impinged by either hot gas 110 or working fluid 122 (each shown in FIG. 1), for example. As a rotational speed of blisk 200 increases, torsional force 212 causes rotor blades 206 and shroud segments 208 to deflect (i.e., untwist) in a rotational direction 218 about a radial axis 220 of blisk 200. A size of gap 210 is selected that allows rotor blades 206 and shroud segments 208 to deflect in rotational direction 218, and that facilitates frictional damping between adjacent shroud segments 208 when power generation system 100 (shown in FIG. 1) reaches a predetermined speed.

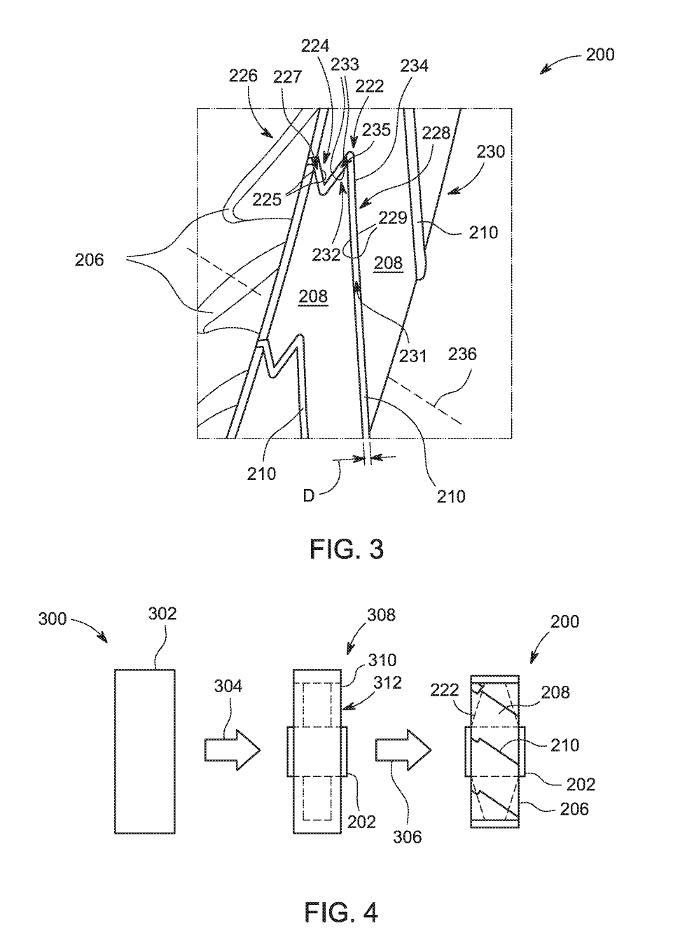

FIG. 3 is an enlarged perspective view of blisk 200 taken along Area 3 (shown in FIG. 2). As described above, gap 210 has a geometry that facilitates interlocking adjacent shroud segments 208 when torsional force 212 (shown in FIG. 2) is applied to rotor blades 206. In the exemplary embodiment, gap 210 has a Z-notch configuration 222 that facilitates defining complementary abutting side wall pairs between adjacent shroud segments 208 that each extend in a different orientation. Specifically, a first complementary side wall pair 224 includes first side walls 225, a second complementary side wall pair 228 includes second side walls 229, and a third complementary side wall pair 232 includes third side walls 233 that each extend between adjacent shroud segments 208. First complementary side wall pair 224 extends from a first side 226 of blisk 200, second complementary side wall pair 228 extends from a second side 230 of blisk 200, and third complementary side wall pair 232 extends between first and second side wall pairs 224 and 228. First side walls 225 define a first truncated gap portion 227 therebetween, second side walls 229 define a second truncated gap portion 231 therebetween, and third side walls 233 define a third truncated gap portion 235 therebetween. Moreover, each complementary side wall pair 224, 228, and 232 extends at oblique angles relative to each other. As such, the geometry of gap 210 is selected to facilitate frictional contact between third side walls 233 of third complementary side wall pair 232 as rotor blades 206 and shroud segments 208 deflect in rotational direction 218.

In the exemplary embodiment, an orientation of gap 210 is selected to ensure a substantially continuous interface (not shown) is formed between side walls 225, 229, and 233 of adjacent shroud segments 208 when power generation system 100 (shown in FIG. 1) reaches a predetermined speed. Specifically, the orientation of gap 210 is selected such that third side wall pair 232 extends substantially perpendicularly relative to a centerline 236 of rotor blades 206. As such, gap 210 between third side wall pair 232 extends substantially perpendicularly relative to centerline 236 and the gap distance is selected to enhance deflection of rotor blades 206 and shroud segments 208, which also enhances frictional damping therebetween. First and second side wall pairs 224 and 228 extend from third side wall pair 232 in orientations that ensure gap 210 extends between adjacent rotor blades 206.

Gap 210 also defines a distance D between adjacent shroud segments 208 selected to ensure frictional contact between adjacent shroud segments 208 at predetermined operating conditions of power generation system 100. Distance D is selected as a function of at least one of a length (not shown) of rotor blades 206 and a predetermined rotational speed of blisk 200. For example, deflection in rotor blades 206 increases as at least one of the length of rotor blades 206 or rotational speed increases, and deflection in rotor blades 206 decreases as at least one of the length of rotor blades 206 or rotational speed decreases. As such, distance D increases as at least one of the length of rotor blades 206 or the rotational speed of blisk 200 increases to facilitate increasing deflection and that ensures frictional contact between adjacent shroud segments 208.

FIG. 4 is a schematic flow diagram illustrating an exemplary sequence 300 of process steps of manufacturing blisk 200. In the exemplary embodiment, blisk 200 is manufactured from a single cylindrical billet 302 of material. Billet 302 is forged or cast from any material that enables blisk 200 to function as described herein. Features of blisk 200 are subsequently defined using any suitable material removal method, including, but not limited to, computer numerical control (“CNC”) milling, electro-chemical machining (“ECM”), and electrical discharge machining (“EDM”).

For example, in the exemplary embodiment, sequence 300 includes a first material removal step 304 and a second material removal step 306. In each of first and second material removal steps 304 and 306, material is removed using any of the above-mentioned material removal methods. First material removal step 304 includes removing material from billet 302 to form an intermediate blisk 308. Specifically, material is removed from billet 302 in a process such as turning or milling such that central disk portion 202, a substantially continuous integral shroud 310, and an outer rim 312 extending between central disk portion 202 and integral shroud 310 are defined therefrom.

Second material removal step 306 includes removing material from intermediate blisk 308 to facilitate forming blisk 200. Specifically, material is removed from outer rim 312 and integral shroud 310 in a process such as ECM or EDM to facilitate defining rotor blades 206 and shroud segments 208, respectively. Defining shroud segments 208 from integral shroud 310 includes defining gaps 210 having Z-notch configurations 222 in integral shroud 310. In an alternative embodiment, blisk 200 is formed using additive manufacturing techniques.

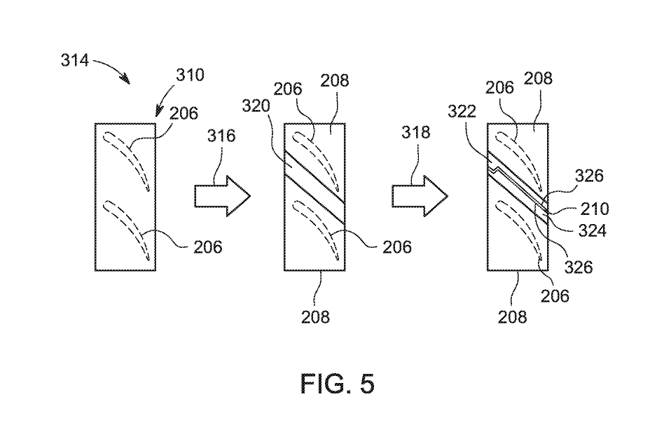

FIG. 5 is a schematic flow diagram illustrating an exemplary sequence 314 of process steps of defining gap 210 between adjacent shroud segments 208. As described above, gap distance D (shown in FIG. 3) is selected as a function of at least one of the length of rotor blades 206 and a predetermined rotational speed of blisk 200. When at least one of the length of rotor blades 206 or the predetermined rotational speed of blisk 200 are comparatively low, distance D required to ensure frictional contact between adjacent shroud segments 208 is also comparatively small. As such, defining gaps 210 in integral shroud 310 in a process such as ECM or EDM may be unable to define gaps 210 having the comparatively small distance D that will ensure frictional contact between adjacent shroud segments 208.

Sequence 314 includes a material removal step 316 and a material insertion step 318. Material removal step 316 includes removing material from integral shroud 310 such that a space 320 is defined between adjacent shroud segments 208. Space 320 is sized to receive a first shroud insert 322 and a second shroud insert 324 therein. Material insertion step 318 includes inserting first and second shroud inserts 322 and 324 within space 320, and coupling shroud inserts 322 and 324 to respective shroud segments 208. Shroud inserts 322 and 324 are pre-formed such that side walls 326 of each shroud insert 322 and 324 define gap 210. Shroud inserts 322 and 324 are coupled to respective shroud segments 208 in a process such as, but not limited to, brazing. As such, pre-forming and inserting shroud inserts 322 and 324 within space 320 facilitates defining gaps 210 of increasingly small sizes between adjacent shroud segments. For example, gap 210 defined by sequence 314 is either a zero gap or an interference fit such that adjacent shroud segments 208 are coupled together with an interference fit even when torsional force 212 (shown in FIG. 2) is not applied to rotor blades 206.

The assembly and methods described herein relate to turbine blisks designed to have improved vibrational damping characteristics. Specifically, the turbine blisks described herein include an integral shroud coupled to each rotor blade. A gap having a predetermined geometry is defined between adjacent shroud segments. The gap allows the rotor blades and the shroud segments to deflect as the rotational speed of the turbine blisk increases towards a predetermined rotational speed. As such, the gap size and geometry are selected such that the shroud segments interlock at the predetermined rotational speed, which provides frictional damping to the turbine blisk assembly.

An exemplary technical effect of the assemblies and methods described herein includes at least one of: (a) providing a shrouded blisk design without broached dovetail slots; (b) providing frictional damping to the blisk; and (c) providing a sequence of process steps for use in forming a frictional contact gap between shroud segments of an integral blisk when the desired gap distance is less than known machining tolerances.

Exemplary embodiments of the turbine blisk are described above in detail. The assembly is not limited to the specific embodiments described herein, but rather, components of systems and/or steps of the methods may be utilized independently and separately from other components and/or steps described herein. For example, the turbine blisk described herein may also be used in combination with other processes, and is not limited to practice with only turbine engines and related methods as described herein. Rather, the exemplary embodiment can be implemented and utilized in connection with many applications where a turbine blisk is operable with a working fluid.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A turbine blisk comprising:
an inner rim;
a plurality of adjacent rotor blades extending radially outward from said inner rim;
a shroud segment integrally coupled to each of said plurality of adjacent rotor blades, thereby forming a plurality of adjacent shroud segments; and
a gap defined between each of said adjacent shroud segments, wherein said gap has a geometry that facilitates interlocking said plurality of adjacent shroud segments when a torsional force is applied to said plurality of adjacent rotor blades.

2. The turbine blisk in accordance with claim 1, wherein said gap defines a plurality of complementary side wall pairs between each of said adjacent shroud segments, each of said plurality of complementary side wall pairs extending at oblique angles relative to each other.

3. The turbine blisk in accordance with claim 2, wherein at least one of said plurality of complementary side wall pairs comprises side walls that are in frictional contact when the torsional force is applied to said plurality of adjacent rotor blades.

4. The turbine blisk in accordance with claim 2, wherein at least one of said plurality of complementary side wall pairs comprises side walls that extend substantially perpendicularly relative to a centerline of each of said plurality of adjacent rotor blades.

5. The turbine blisk in accordance with claim 1, wherein said gap defines a distance between each of said adjacent shroud segments selected as a function of at least one of a length of said plurality of adjacent rotor blades or a predetermined rotational speed of said turbine blisk.

6. The turbine blisk in accordance with claim 1, wherein said gap defines at least one of a zero gap or an interference fit between said adjacent shroud segments.

7. The turbine blisk in accordance with claim 1, wherein said gap comprises a Z-notch configuration.

8. A power generation system comprising:
a source of working fluid; and
a turbine coupled downstream from said source of working fluid, wherein said turbine comprises at least one turbine blisk comprising:
an inner rim;
a plurality of adjacent rotor blades extending radially outward from said inner rim;
a shroud segment integrally coupled to each of said plurality of adjacent rotor blades, thereby forming a plurality of adjacent shroud segments; and
a gap defined between each of said adjacent shroud segments, wherein said gap has a geometry that facilitates interlocking said plurality of adjacent shroud segments when a torsional force is applied to said plurality of adjacent rotor blades.

9. The system in accordance with claim 8, wherein said gap defines a plurality of complementary side wall pairs between each of said adjacent shroud segments, each of said plurality of complementary side wall pairs extending at oblique angles relative to each other.

10. The system in accordance with claim 9, wherein at least one of said plurality of complementary side wall pairs comprises side walls that are in frictional contact when the torsional force is applied to said plurality of adjacent rotor blades.

11. The system in accordance with claim 9, wherein at least one of said plurality of complementary side wall pairs comprises side walls that extend substantially perpendicularly relative to a centerline of each of said plurality of adjacent rotor blades.

12. The turbine blisk in accordance with claim 8, wherein said gap comprises a Z-notch configuration.

13. A method of manufacturing a turbine blisk, said method comprising:
providing a solid billet of material;
defining an inner rim from the solid billet of material;
defining a plurality of adjacent rotor blades from the solid billet of material, the plurality of adjacent rotor blades extending radially outward from the inner rim;
defining a shroud from the solid billet of material, the shroud integrally coupled to the plurality of adjacent rotor blades; and
defining a gap in the shroud to form a shroud segment integrally coupled to each of the plurality of adjacent rotor blades, thereby forming a plurality of adjacent shroud segments, wherein the gap has a geometry that facilitates interlocking the plurality of adjacent shroud segments when a torsional force is applied to the plurality of adjacent rotor blades.

14. The method in accordance with claim 13, wherein defining a gap comprises defining a plurality of complementary side wall pairs between each of the plurality of adjacent shroud segments, each of the plurality of complementary side wall pairs extending at oblique angles relative to each other.

15. The method in accordance with claim 14, wherein defining a plurality of complementary side walls pairs comprises extending at least one of the plurality of complementary side wall pairs substantially perpendicularly relative to a centerline of each of the plurality of adjacent rotor blades.

16. The method in accordance with claim 13, wherein defining a gap comprises selecting a distance between each of the plurality of adjacent shroud segments as a function of at least one of a length of the plurality of adjacent rotor blades or a predetermined rotational speed of the turbine blisk.

17. The method in accordance with claim 13, wherein defining a gap comprises:
removing material from the shroud to define a space between each of the plurality of adjacent shroud segments; and
inserting shroud inserts within the space such that the gap is defined between the shroud inserts.

18. The method in accordance with claim 17 further comprising pre-forming the shroud inserts such that side walls of each shroud insert define the gap.

19. The method in accordance with claim 13 further comprising removing material from the solid billet of material by at least one of computer numerical control milling, electro-chemical machining, or electrical discharge machining.

20. The method in accordance with claim 13, wherein providing a solid billet of material comprises one of forging the solid billet and casting the solid billet.
